(19) United States
(12) Patent Application Publication
(10) Pub. No.: US 2005/0286367 A1
(43) Pub. Date: Dec. 29, 2005

(54) Method for recording and reproducing data and apparatus for the same

(75) Inventors: Mitsuya Okada, Tokyo (JP); Yutaka Yamanaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/165,199

(22) Filed: Jun. 24, 2005

(30) Foreign Application Priority Data
Jun. 25, 2004 (JP) 187284/2004

(51) Int. Cl. G11B 15/52

(52) U.S. Cl. 369/47.12; 369/84

(57) ABSTRACT

In a method of carrying out a recording operation and a reproducing operation to a data record medium, the data record medium contains a data area, and a system area containing at least one of record control data areas, in each of which record control data for user data recorded in the data area has been recorded. This method is achieved by extending a record control data area in a data area, and by recording a replica of the record control data containing a latest record control data in a predetermined replica record control data area of the data record medium when the record control data area is extended.

### CROSS REFERENCE TO RELATED APPLICATIONS

This application is related to the U.S. patent application Ser. No. 11/111,758. The disclosure of the U.S. patent application Ser. No. 11/111,758 is incorporated herein by reference.

Also, this application is related to the U.S. patent application Ser. No. 11/111,767. The disclosure of the U.S. patent application Ser. No. 11/111,767 is incorporated herein by reference.

Also, this application is related to the U.S. patent application Ser. No. 11/136,863. The disclosure of the U.S. patent application Ser. No. 11/136,863 is incorporated herein by reference.

### BACKGROUND OF THE INVENTION

1. Field of the Invention

The present invention relates to a recording and reproducing method for an optical disc medium as a data recording and reproducing medium, and an apparatus for the same.

2. Description of the Related Art

As development of file equipment technology in recent years, an optical disc as one of data recording and reproducing media has rapidly achieved a large capacity. In the field of reproduction-only type media, a music CD (Compact Disc) and a CD-ROM (CD-Read Only Memory) for data distribution have been widely spread. These discs can easily handle data of a large capacity of 650 MB to 800 MB. Further, a DVD (Digital Versatile Disc) using infrared of the wavelength of about 650 nm comes into practice in place of the CD using infrared of the wavelength of about 780 nm. The DVD can record data seven times or more of the CD, and therefore, record a picture image of two hours or more.

In these reproduction-only discs, small pits are formed previously on a resin substrate of polycarbonate for data record. Recently, a write-once type optical disc with an identical reproducing performance has been rapidly widespread. These are called as a CD-R (CD-Recordable) and a DVD-R (DVD-Recordable). These discs are formed by coating an organic pigment layer on a polycarbonate resin substrate with a spiral guide groove. The organic pigment layer has absorption of light of a wavelength. The pits are formed in a record layer by a focused laser beam. Such a write-once type optical disc after these pits are formed has reproduction and servo characteristics equivalent to the reproduction-only type optical disc. Therefore, the write-once type optical disc can be reproduced by a reproduction-only type driving apparatus.

In the write-once type optical disc (recordable optical disc), e.g., the DVD-R, in order to keep compatibility with the reproduction-only type optical disc, user data is converted to have an address data and an error correction data before a recording operation, and the data after the conversion is recorded in the disc. The format of data recorded in this way is equivalent to that of DVD-ROM, and the data reproducing can be achieved by the reproduction-only type driving apparatus.

If the record type optical disc has completely the same format as the reproduction-only type optical disc, data necessary to carry out an additional recording operation cannot be acquired after the recording operation is ended once. To avoid this inconvenience, the formats such as a multi-session format or a multi-border format are used in the recordable type optical disc. In the multi-session format, a disc area is divided into a plurality of record areas to permit the additional recording operation. In these formats, an area is secured to record a disc record control data (a record control data) containing a position data. In the DVD-R of the multi-border, an area for the record control data is formed in the head portion of each user data area. A driving apparatus for the recordable type optical disc can carry out the additional recording operation by referring to this record control data. Moreover, the reproduction-only type disc driving apparatus can also access necessary user data by referring to record control data.

A conventional recording apparatus is disclosed in Japanese Laid Open Patent Application (JP-P2000-504462A: first conventional example) as a disc driving apparatus for the optical disc having such a record control data. In this conventional driving apparatus, a first detection section detects a used area on the basis of a use data of a record medium. A second detection section detects an unwritten border area on the basis of a state data that shows an area written state of the record medium. Moreover, an initialization section is provided with a state detection section to detect the state data showing a written or unwritten state of the area of the record medium. Further, the record medium is provided with a status data to show the written or unwritten state of the area. The status data can be reproduced in a predetermined format. More specifically, a bitmap is recorded in a predetermined address of the record medium in which the use data are not recorded, e.g., a predetermined position in a lead-in area or a predetermined position before the lead-in area is recorded to show whether a use data (a user data) has been recorded. Similarly, the status data is recorded in a predetermined position of the record medium, e.g., in the lead-in area in which the use data is not recorded or before the lead-in area in a bitmap format, to show whether or not the recording operation is carried out to each of areas of the record medium.

A conventional writing apparatus is described in Japanese Laid Open Patent Application (JP-P2000-504463A: second conventional example). In the writing apparatus of the second conventional example, a section is provided to generate a state data to show a fact that the recording operation is carried out to at least one of areas of the record medium. The state data contains an interval data indicating the positions of a start portion and end portion of an initial area of a track pattern where a data is recorded without interruption. A bitmap data shows areas where the state data are written area and unwritten areas. Moreover, the record medium contains a state data to show a fact that a recording operation is carried out to at least one area. This state data contains an initial area data to show the initial area where the data is written without any interruption, and which extends from the start portion of the track pattern to write a data block.

Moreover, Japanese Laid Open Patent Application JP-P2003-228853A (third conventional example) discloses a procedure to search the latest record management data (RMD) described in a record management data area (RMA) in a driving apparatus for the recordable type disc such as the DVD-R.

In conjunction with the above description, a disc recording method is disclosed in Japanese Laid Open Patent Application (JP-P2002-312940A). This conventional example relates to the disc recording method of recording data in a write-once type disc in units of sectors. The disc has a track having formed concentrically or a spiral manner and the track is divided into a plurality of sectors. In the method, a position data of areas in which data have been recorded is held in a memory while being updated every time of record of the data. The position data held in the memory is compared with a position data of data recorded areas in the disc. When the comparing result indicates non-coincidence, the position data held in the memory is recorded in the disc.

### SUMMARY OF THE INVENTION

An object of the present invention is to provide a method for acquiring the latest record control data efficiently and a data recording and reproducing apparatus for the same.

In an aspect of the present invention, a method of carrying out a recording operation and a reproducing operation to a data record medium is provided. The data record medium contains a data area, and a system area containing at least one of record control data areas, in each of which record control data for user data recorded in the data area has been recorded. This method is achieved by extending a record control data area in a data area, and by recording a replica of the record control data containing a latest record control data in a predetermined replica record control data area of the data record medium when the record control data area is extended.

Here, it is preferable that the replica record control data contains at least one of a data indicating a position of the extended record control data area and a data indicating a position of a currently used one of the record control data areas.

Also, the method may be achieved by further recording the record control data of the record control data area in the replica record control data area, after an initial setting which is carried out on a first use of the data record medium.

Also, the method may be achieved by further searching the latest record control data having been recorded in the data record medium. The searching may be achieved by acquiring a data indicating positions of the record control data areas based on the replica record control data; and by accessing the record control data area having been used immediately before the last extension, when the record control data area is extended last.

Also, the accessing may be achieved by determining whether or not the record control data is recorded in an end portion of the record control data area having been used immediately before the last extension; by (a) searching the latest record control data in a direction from the end portion of the record control data area having been used immediately before the last extension toward a head portion thereof, when it is determined that the record control data has not been recorded in the end portion of the record control data having been used immediately before the last extension; by acquiring as the latest record control data, the record control data searched first through the (a) searching; by temporarily storing the record control data having been recorded in the end portion of the record control data having been used immediately before the last extension, when it is determined that the record control data has been recorded in the end portion of the record control data; and by accessing the last extended record control data area, after the temporary storing.

Also, the accessing may be achieved by further determining whether or not the record control data has been recorded in the last extended record control data area; by acquiring the temporarily stored record control data as the latest record control data when it is determined that the record control data has not been recorded in the last extended record control data area; and by acquiring the record control data having been recorded last in the last extension record control data area as the latest record control data when it is determined that the record control data has been recorded in the last extended record control data area.

In another aspect of the present invention, a method of carrying out a recording operation and a reproducing operation to a data record medium is provided. The data record medium contains the data area, and a system area containing at least one of record control data areas, in each of which record control data for user data recorded in the data area has been recorded. The method is achieved by extending a record control data area in a data area, by recording a replica of the record control data containing a latest record control data in a predetermined replica record control data area of the data record reproduction medium; and by recording a predetermined data in a non-record area of the record control data area.

Here, it is preferable that the replica record control data contains a data indicating a position of the record control data area extended in the data area.

Also, the method may be achieved by further recording the record control data of the record control data area in the replica record control data area, after initial setting which is carried out on a first use of the data record medium.

Also, the method may be achieved by further searching the latest record control data in the data record reproduction medium. The searching may be achieved by acquiring a data indicating positions of the record control data areas based on the replica record control data; by temporarily storing the replica record control data; by determining whether or not the record control data has been recorded in a last extended one of the record control data areas; by acquiring the record control data recorded last in the last extended record control data area as the latest record control data when it is determined that the record control data has been recorded; and by acquiring the temporarily stored replica record control data as the latest record control data when it is determined that the record control data has not been recorded.

In another aspect of the present invention, a data recording and reproducing apparatus includes a recording section configured to write-access a data record medium; a reproducing section configured to read-access the data record medium; and a control section configured to control the recording section and the reproducing section. The data record medium comprises a data area, and a system area containing at least one of record control data areas, in each of which record control data for user data recorded in the data area has been recorded. The control section controls the recording section to extend the record control data area in the data area, and to record a replica of the record control data containing a latest record control data in a predetermined replica record control data area of the data record medium when the record control data area is extended.

Here, it is preferable that the replica record control data contains at least one of a data indicating a position of the extended record control data area and a data indicating a position of a currently used one of the record control data areas.

Also, the control section may control the recording section to record the record control data of the record control data area in the replica record control data area, after an initial setting which is carried out on a first use of the data record medium.

Also, the control section may control the reproducing section to acquire a data indicating positions of the record control data areas based on the replica record control data. The control section may control the reproducing section to access the record control data area having been used immediately before the last extension when the control section controls the recording section to extend the record control data area last. In this case, the control section may determine whether or not the record control data is recorded in an end portion of the record control data area having been used immediately before the last extension. The control section may control the reproducing section to search the latest record control data in a direction from the end portion of the record control data area having been used immediately before the last extension toward a head portion thereof, when the control section determines that the record control data has not been recorded in the end portion of the record control data having been used immediately before the last extension, and to acquire as the latest record control data, the record control data searched first through the search. The control section may temporarily store the record control data having been recorded in the end portion of the record control data having been used immediately before the last extension in a buffer memory, when the control section determines that the record control data has been recorded in the end portion of the record control data. The control section may control the reproducing section to access the last extended record control data area, after the temporary storing.

In addition, the control section may determine whether or not the record control data has been recorded in the last extended record control data area. The control section may control the reproducing section to acquire the temporarily stored record control data as the latest record control data when the control section determines that the record control data has not been recorded in the last extended record control data area. The control section may control the reproducing section to acquire the record control data having been recorded last in the last extension record control data area as the latest record control data when the control section determines that the record control data has been recorded in the last extended record control data area.

In another aspect of the present invention, a data recording and reproducing apparatus includes a recording section configured to write-access a data record medium; a reproducing section configured to read-access the data record medium; and a control section configured to control the recording section and the reproducing section. The data record medium includes a data area, and a system area containing at least one of record control data areas, in each of which record control data for user data recorded in the data area has been recorded. The control section controls the recording section to extend the record control data area in the data area, to record a replica of the record control data containing a latest record control data in a predetermined replica record control data area of the data record reproduction medium, and to record a predetermined data in a non-record area of the record control data area.

Here, it is preferable that the replica record control data contains a data indicating a position of the record control data area extended in the data area.

Also, the control section may control the recording section to record the record control data of the record control data area in the replica record control data area, after initial setting which is carried out on a first use of the data record medium.

In addition, the control section may control the reproducing section to acquire a data indicating positions of the record control data areas based on the replica record control data. The control section may temporarily store the replica record control data in the buffer memory, and determines whether or not the record control data has been recorded in a last extended one of the record control data areas. Also, the control section may control the reproducing section to acquire the record control data recorded last in the last extended record control data area as the latest record control data when the control section determines that the record control data has been recorded, and to acquire the temporarily stored replica record control data as the latest record control data when the control section determines that the record control data has not been recorded.

### BRIEF DESCRIPTION OF THE DRAWINGS

FIG. 1 is a block diagram showing a configuration of a data recording and reproducing system of the present invention;

FIG. 2 is a block diagram showing a configuration of a data recording and reproducing apparatus according to the present invention;

FIG. 3 is a diagram showing a structure of an optical disc medium according to the present invention;

FIG. 4 is a diagram showing the structure of areas of the optical disc medium according to the present invention;

FIG. 5 is a diagram showing another structure of areas of the optical disc medium according to the present invention;

FIG. 6 is a diagram showing a structure of areas of the optical disc medium according to the present invention;

FIG. 7 is a diagram showing a data format of an extended record control data area of record control data according to the present invention;

FIG. 8 is a flow chart according to the of a first operation of the data recording and reproducing apparatus according to an embodiment of the present invention;

FIGS. 9A to 9C are schematic diagrams showing states of the areas of the optical disc medium in the first operation of the data recording and reproducing apparatus according to the embodiment of the present invention;

FIG. 10 is a flow chart according to a second operation of the data recording and reproducing apparatus according to an embodiment of the present invention;

FIGS. 11A to 11C are schematic diagrams showing states of the areas of the optical disc medium in the first operation of the data recording and reproducing apparatus according to the embodiment of the present invention;

FIG. 12 is a flow chart according to a third operation of the data recording and reproducing apparatus according to an embodiment of the present invention;

FIGS. 13A to 13D are schematic diagrams showing states of the areas of the optical disc medium in the third operation of the data recording and reproducing apparatus according to the embodiment of the present invention;

FIG. 14 is a flow chart according to a fourth operation of the data recording and reproducing apparatus according to an embodiment of the present invention; and

FIGS. 15A to 15D are schematic diagrams showing states of the areas of the optical disc medium in the fourth operation of the data recording and reproducing apparatus according to the embodiment of the present invention.

### DESCRIPTION OF THE PREFERRED EMBODIMENTS

Hereinafter, a data recording and reproducing medium, a data recording and reproducing apparatus, and a method of the data recording and reproducing in accordance with the present invention will be described in detail with reference to attached drawings.

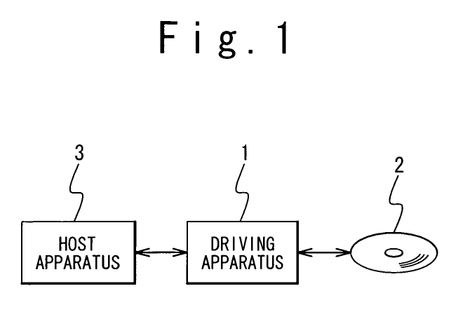

FIG. 1 shows a configuration of the data recording and reproducing system of the present invention. The data recording and reproducing system includes an optical disc apparatus (a data recording and reproducing apparatus), an optical disc medium 2 and a host apparatus 3. The optical disc medium 2 is set in the optical disc apparatus 1 as a data recording and reproducing apparatus. The optical disc medium 2 is such as a CD and a DVD. The optical disc apparatus 1 records data in the optical disc medium 2 and reproduces the data from the optical disc medium 2 based on an instruction of the host apparatus 3. Moreover, the optical disc apparatus 1 carries out a record training process prior to the recording operation to confirm and adjust a recording condition in accordance with the instruction of the host apparatus 3. In the reproducing operation, the optical disc apparatus 1 confirms and adjusts circuit constants of the reproducing signal processing system and the like in accordance with the instruction of the host apparatus 3 in order to carry out the reproducing operation under the condition of a low error rate.

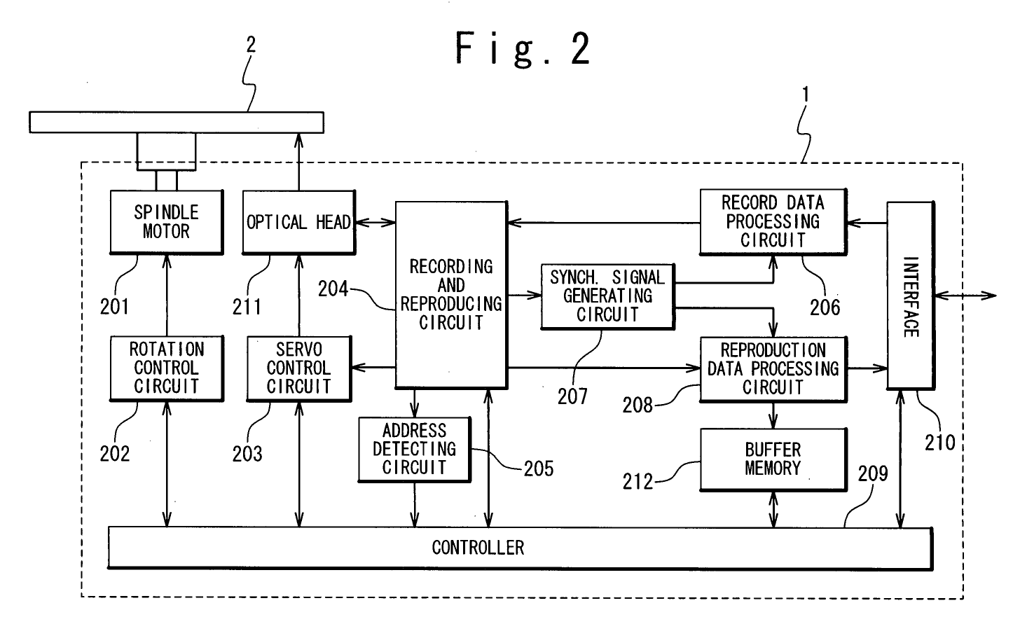

FIG. 2 is a circuit block diagram showing a configuration of the optical disc apparatus 1. Details of the configuration are shown to carry out the recording and reproducing operations in the optical disc medium 2 as an example of the data recording and reproducing medium.

The optical disc apparatus 1 includes a spindle motor 201, a rotation control circuit 202, an optical head 211, a recording and reproducing circuit 204, a servo control circuit 203, an address detecting circuit 205, an interface 210, a record data processing circuit 206, a reproduction data processing circuit 208, a controller 209, a synchronization signal generating circuit 207, and a buffer memory 212.

The spindle motor 201 supports and rotates the optical disc medium 2. The rotation control circuit 202 controls the rotation of the spindle motor 201 in accordance with an instruction signal from the controller 209.

The optical head 211 irradiates a laser beam from a built-in laser to focus on a predetermined position on the rotating optical disc medium 2 in response to a driving signal from the recording and reproducing circuit 204. In the reproducing operation, the optical head 211 detects a reflected laser beam from the optical disc medium 2. In the recording operation, the optical head 211 irradiates the laser beam of higher power than in the reproducing operation. In the reproducing operation, the recording and reproducing circuit 204 amplifies a detection signal from the optical head 211 to generate various signals such as a reproduction data signal, a focus servo error signal, a tracking servo error signal and the like. In the recording operation, the recording and reproducing circuit 204 supplies a desired recording data to the optical head 211 based on a record data signal supplied from the record data processing circuit 206.

The servo control circuit 203 carries out a focus control and a tracking control for the optical head 211 in order to control the position of the optical head 211 in response to the servo error signal form the recording and reproducing circuit 204 and an instruction signal from the controller 209. When address data are allocated to areas of the optical disc medium 2, it is necessary to extract the address data from the reproduction signal by using the address detecting circuit 205. Here, the address data is acquired to detect the position of the laser beam on the optical disc medium 2 by decoding a pre-pit address signal or a wobble signal superimposed on grooves meandering.

The record data processing circuit 206 adds an error correction code to record data from the interface 210 to generate a record data. Moreover, the record data processing circuit 206 converts the record data to have a suitable format for the recording operation in accordance with a record synchronization signal from a synchronizing signal generating circuit 207. The synchronization signal generating circuit 207 generates the synchronization signal based on a signal reproduced by the optical disc medium 2.

The reproducing data processing circuit 208 decodes a reproduction signal from the recording and reproducing circuit 204, corrects an error of a reproducing data, then, and sends the corrected data to the interface 210. The interface 210 receives the record reproduction instruction data and the record reproduction data from the host apparatus 3. The buffer memory 212 temporarily stores the reproduction data.

The controller 209 is connected with the rotation control circuit 202 and servo control circuit 203, the address detecting circuit 205, the recording and reproducing circuit 204, the buffer memory 212, and the interface 210 and controls each unit.

The recordable optical disc medium 2 such as a DVD-R and a DVD-RW used in the optical disc apparatus l(data recording and reproducing apparatus 1) has a multi-layer structure. That is, an organic pigment, a metal thin film of a phase-changeable type and the like are coated on a polycarbonate resin substrate having a spiral guide groove. The organic pigment and the metal thin film of the phase-changeable type have a high absorption to light with a certain wavelength, and the change in shape or reflectance is caused by the focused laser beam. By using this property, the pits and the like can be formed along the guide groove to record a data. After the pits and the like are formed, the recordable optical disc medium 2 shows a reproduction characteristic and a servo characteristic identical to that of a reproduction-only type optical disc. As a result, the reproducing operation of data is possible even by the reproduction-only type drive.

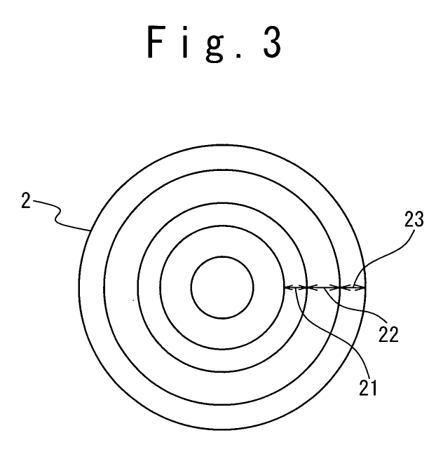

The record area of the recordable optical disc medium 2 is divided into areas so as to record and reproduce data in a good state while keeping compatibility with the above-mentioned reproduction-only type drive in reproduction. As shown in FIG. 3, the recording area of the optical disc medium 2 is divided in a concentric circular manner from the inner circumference of the optical disc medium 2, and a system area 21, a user data area 22 a lead-out area 23 are provided in this order. In the following description, it is assumed that data is recorded from the inner side toward the outer circumference side of the optical disc medium 2. It should be noted that the word “inner” and the word “outer” are exchanged when data is recorded from the outer circumference side to the inner side.

A system data that is effective for the recording and reproducing operations is stored in the system area 21. The system data includes a data concerning the disc such as a data of a kind of disc, data of physical characteristics and the like, and a data of the user data area where data was already recorded, and further includes a data of recommended operating conditions of a data recording and reproducing apparatus concerned with control of a disc operation, and the like. Furthermore, the system data includes a test area for a record condition adjustment of the data recording and reproducing apparatus 1.

The user data area 22 is an area where a user data is recorded. The user data area 22 is provided on an outer circumference side of the system area 21 and has a recording track that is formed in a spiral manner. The user data is recorded in this recording track. Generally, the recording operation is carried out from the inner circumference side toward the outer circumference side of the disc in the user data area 22.

The lead-out area 23 is provided on the outer circumference side of the user data area 22, to show that data is not recoded in this area. The data recording and reproducing apparatus 1 carries out an end operation when reproducing the lead-out area. Data having a predetermined pattern is recorded in this area. Therefore, the data recording and reproducing apparatus 1 can detect the lead-out area 23 from reproduction data. On the other hand, in the record operation, when the recording operation of the user data in the optical disc medium 2 is completed and the recording operation is not carried out after that, in other words, when the optical disc medium 2 is used as a reproduction-only disc thereafter, the data having the predetermined pattern is recorded to show the lead-out area in the outer circumference side of the user data area 22.

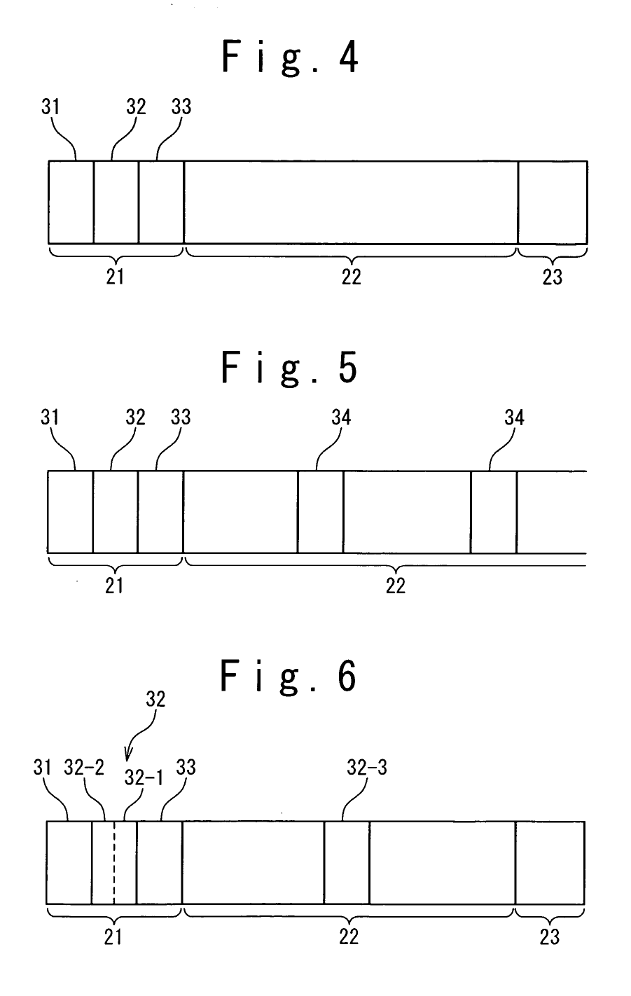

FIG. 4 is a diagram showing the record area of the optical disc medium 2 to show each area provided from the inner circumference side to the outer circumference side in the disc. The system area 21 is arranged in the innermost circumference side of the disc. In the system area 21, a system control data that is used in the recording and reproducing operation by the optical disc apparatus is stored. Further, data showing where various data are arranged in the disc medium is also stored.

The system area 21 includes typically a user data lead-in area 33, a record control data area 32, and a test record area 31.

The user data lead-in area 33 is arranged at the nearest position to the data area 22. The system control data is mainly stored in the user data lead-in area 33, and is needed when the recordable type optical disc medium is reproduced by the reproduction-only data recording and reproducing apparatus.

The record control data area 32 mainly stores a record control data used when the data recording and reproducing apparatus records the user data in the user data area 22. That is, various data are recorded such as a data indicating an address of an area of the user data area 22 usable in a next recording operation, and a data indicating a use state of a test record area. Each time the data area 22 is used for the recording operation, and the test record area is used, data recorded in the record control data area is updated. In other words, data is recorded in the record control data area 32 for every record unit when the data is recorded in the disc medium.

The test record area 31 is an area used to find the optimal recording condition when the recording operation is carried out on the disc medium by the data recording and reproducing apparatus. The record condition is adjusted by using this area before the recording operation in the data area is carried out actually. Specifically, a recording operation is carried out while changing a power, a waveform in the recording operation and the like in accordance with a preferable procedure, and then the optimal recording condition is determined in accordance with the reproduction characteristic.

Formats such as a multi-session format and a multi-border format are defined as standards of logical format of the optical disc medium to enable the user to record the user data additionally by dividing the user data area 22, in addition to a format that the user data area 22 is formed as a block, as shown in FIG. 4. For instance, in the multi-border format, as shown in FIG. 5, the user data area 22 is divided into a plurality of areas called bordered areas. The bordered areas are separated by a border area 34. This format makes it possible to reproduce the user data by the reproduction-only data recording and reproducing apparatus while subsequent additional recording operations are permitted without carrying out a finalizing process. The finalizing process is a process for forming the lead-out area so that the optical disc medium 2 is used as a reproduction only disc medium thereafter.

The record control data is recorded in the record control data area 32 each time the additional recording is carried out or the recording operation is carried out over a predetermined time period. For these reasons, if the additional recording operations are frequently carried out, the record control data area 32 provided in the inner circumference side of the disc medium is insufficient in size, so that the record control data cannot be recorded. If the record control data cannot be recorded in the record control data area 32, the user data cannot be recorded in the data area 22. To solve this problem, as shown in FIG. 6, an extended record control data area 32-3 is provided in the user data area 22 to record the record control data additionally.

In case of the multi-border format, the extended record control data area may be provided in the border area 34. Moreover, the record control data area 32 might be extended. It is preferable that the extended record control data area has a record capacity enough to record a plurality of record control data. Also, it is preferable that the extension of the record control data area is carried out at a time when a remaining record capacity of the record control data area used currently becomes lower than a predetermined value. That is, the extending operation is preferably carried out at a time when the number of record control data that can be recorded in the currently used record control data area becomes less than the predetermined value. In the extending operation, a method may be employed in which an unused portion of the currently used record control data area is filled with a predetermined pattern as a kind of dummy data not to permit the additional recording operation in that portion. In this case, a usable extended record control data area after the extending operation is necessarily determined. Therefore, the driving control operation can be made smooth. The predetermined pattern is, for example, a specific pattern of data such as 00h or FFh, or the latest record control data. It should be noted that when the record control data area is lack again after the extension of the record control data area, the extending operation of the record control data area may be carried out again.

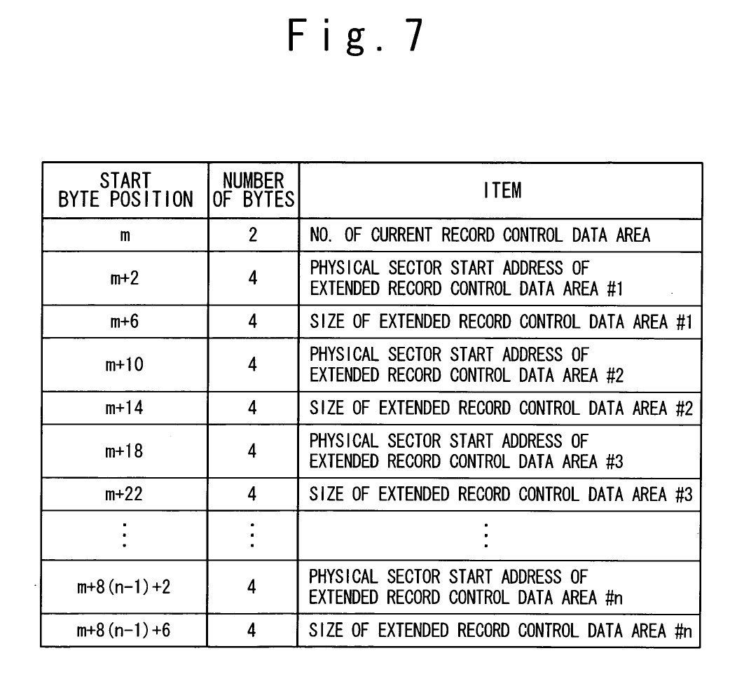

The record control data includes a data concerned with the record control that is needed when the data recording and reproducing apparatus 1 records the user data in the user data area 22, a data of the address of a usable area of the user data area 22 in the next recording operation, and a data of the use state of the test record area 31. For instance, a data concerned with the extended record control data area the record control data may be configured as shown in FIG. 7. That is, the data concerned with the extended record control data area is recorded in a field of the record control data. As the data concerned with the extended record control data area, the following data are recorded in two to four bytes, respectively:
(1) the number of the currently used record control data area;
(2) start addresses of physical sectors of the extended record control data areas of the numbers 1 to n; and
(3) sizes of the physical sectors of extended record control data areas of the numbers 1 to n. In this case, the record control data area can be specified from the number of the currently used record control data area, and the address data of the extended record control data area can be acquired. Similarly, when the number of the extended record control data area is specified, the extended record control data area can be specified and the address data of the extended record control data area can be acquired. Thus, the search becomes easy

When the additional recording operation in optical disc medium 2 is carried out, it is important to reproduce the latest record control data from the optical disc medium 2 efficiently. In other words, for the additional recording operation in the optical disc medium 2, it is need to recognize how much empty area is in the user data area at the start of the addition recording operation. The delay of the reorganizing operation leads to entire delay of the recording operation. That is to say, when the extended record control data area 32-3 is set, the latest record control data needs to be searched efficiently from among the distributed record control data stored. Also, the recording method of the record control data that is suitable for the efficient search should be provided.

To solve these problems, first, a mechanism is necessary to easily find whether the record control data area is extended or not, and where is the extended record control data area. In the extension of the record control data area, if the data concerned with a newly set extended record control data area 32-3 is separately recorded each time the extended record control data area 32-3 is newly set, the arrangement of the extended record control data areas can be found only by referring to the data concerned with the set extended record control data areas. That is, the record control data containing the position data such as the address and setting history data of the newly set extended record control data is copied as a replica of record control data, which is recorded in a predetermined area in the optical disc medium 2 as a copied (replica) record control data.

A copied record control data area where the copied record control data is recorded needs to be determined previously. Therefore, it is preferable that it is set in a portion of the record control data area 32 on the inner circumference side of the optical disc medium 2. For instance, as shown in FIG. 6, a portion of the record control data area 32 is used as the copied record control data area 32-2 to record the copied record control data. In this embodiment, the copied record control data area 32-2 is provided on the inner circumference side of the record control data area 32. Hereinafter, the record control data area where an original record control data is stored is referred to as a basic record control data area 32-1, and the record control data area extended in the user data area 22 or the border area 34 is referred to as an extended record control data area 32-3.

The latest record control data at that time is additionally recorded in the copied record control data area 32-2 as the copied record control data each time the record control data area is extended. Therefore, by referring to the latest copied record control data recorded here, the arrangement of the extended record control data areas 32-3 set in the user data area 22 or the border area 34 can be recognized. That is, by accessing the copied record control data area 32-2, and obtaining the latest copied record control data, the data of the extension of the record control data area 32 can be acquired. Thus, an efficient access to the latest record control data can be possible.

Even before the extended record control data area 32-3 is set, it is possible to record the copied record control data in this copied record control data area 32-2. In other words, a copy of the record control data is recorded in this copied record control data area 32-2 at the time when the record control data is first recorded. As a result, even before the record control data area 32 is extended, it is possible to recognize the latest record control data area only by accessing this copied record control data area 32-2.

The data recording and reproducing apparatus reproduces the copied record control data in the record control data area in order to confirm an area in which the latest record control data is recorded. When the extending operation of the record control data area has not been carried out, the data recording and reproducing apparatus acquires a data of no record, since the copied record control data has not been recorded here. Also, in place to this method, a method may be employed in which the copy of the record control data is recorded in this area as a first copied record control data even before the extended record control data area is set.

Also, in another method to search the latest record control data efficiently and reproduce necessary data, when the record control data recorded in the extended record control data area 32-3, An extended record control data area 32-3′ that is set immediately before the latest extended record control data area 32-3 is set without directly accessing the latest extended record control data area 32-3. The reason is that there is a case where only the extending operation out of the latest extended record control data area 32-3 is carried and the latest record control data has not been recorded yet there. First, the extended record control data area 32-3′ set previously once is searched, and the latest extended record control data area 32-3 is searched only when data are recorded in the whole area. It should be noted that when the latest extended record control data area 32-3 is extended in the optical disc medium 2 for the first time, the extended record control data area 32-3 previous once becomes the basic record control data area 32-1.

Moreover, when the extended record control data area 32-3′ set immediately previously or the basic record control data area 32-1 having used immediately before the extension is searched, the searching operation is not carried out from the head portion of this area but searched from the end portion of the area. This is because the additional recording operation of the record control data is usually carried out from the inner circumference side of the optical disc medium 2 as the head portion of the area, so that the latest record control data is recorded on the outer circumference side. Also, that is because the extending operation is already carried out to set the latest extended record control data area 32-3. The record control data are recorded in the almost whole of extended record control data area after the extending operation. Therefore, it is shown that the latest record control data is recorded on the outer circumference side as the end of this area. As mentioned above, it is possible to search the latest record control data more quickly by searching from the outer circumference side as the end of the area.

In addition, in an effective method of to high-speed searching operation, a memory is provided for the data recording and reproducing apparatus 1 to store the latest record control data. The latest record control data recorded previously in the copied record control data area 32-2 is stored in the memory installed in the data recording and reproducing apparatus 1. If the record control data does not exist in the area when the latest extended record control data area is accessed, the copied record control data area 32-2 or the record control data area having been used is not accessed again but the latest record control data stored in the memory is accessed. As mentioned above, the copied record control data containing the latest record control data is recorded in the copied record control data area 32-2 provided on the inner circumference side of the disc, every time the extended record control data area 32-3 is newly set.

The data recording and reproducing apparatus 1 reproduces the copied record control data from the copied record control data area 32-2 on the inner circumference side of the disc in order to obtain the data of the extended record control data area 32-3. Then, the data recording and reproducing apparatus 1 accesses the immediately previously extended record control data area 32-3′ based on the acquired data. When the extended record control data area 32-3′ (or the basic record control data area 32-1) is wholly filled with the record control data or the predetermined data such as the dummy data, the data recording and reproducing apparatus 1 accesses the latest extended record control data area 32-3. When only the extending operation is carried out and the latest extended record control data area 32-3 has not been recorded, the record control data that has been recorded last the record control data area 32 (the extended record control data area 32-3′ or the basic record control data area 32-1), that has been used immediately before the latest extended record control data area 32-3 is extended, is the latest record control data. Therefore, it is necessary to access the record control data area 32 that has been used immediately before the latest extended record control data area 32-3 is extended (the extended record control data area 32-3′ or the basic record control data area 32-1) in order to obtain the record control data therefrom. Thus, it takes a long time for the access.

On the other hand, in place to the above, when the latest record control data is not recorded in the latest extended record control data area 32-3, the latest record control data recorded in the copied record control data area 32-2 is stored in the buffer memory 212 that is installed in the data recording and reproducing apparatus 1, and the contents of the buffer memory 212 are handled as the latest record control data. This is because the record control data recorded in the copied record control data area 32-2 is a record control data when the extended record control data area 32-3 is extended, and the record of the record control data after that does not exit. Therefore, the control data becomes the last (latest) record control data. Therefore, it is possible to acquire the latest record control data from the buffer memory 212 without accessing the record control data area 32 that has been used immediately before the latest extended record control data area 32-3 is extended (the extended record control data area 32-3′ or the basic record control data area 32-1). Thus, the access time can be shortened.

This method is effective when a predetermined data such as the dummy data is recorded in the extended record control data area 32-3′ that has been used in the extending operation. That is, when the record control data is not recorded in the latest extended record control data area 32-3, the record control data recorded in the copied record control data area 32-2 becomes the latest record control data. Therefore, in this case, the data recording and reproducing apparatus 1 reproduces the data of the copied record control data area 32-2 on the inner circumference side of the disc in order to obtain the data of the extended record control data area 32-3, and then, accesses the latest extended record control data area 32-3 based on the data. It is not needed to access the extended record control data area 32-3′ set previously once. The latest record control data recorded in the copied record control data area 32-2 is previously stored in the buffer memory 212 of the data recording and reproducing apparatus 1. The contents in the buffer memory 212 are handled as the latest record control data when the record control data does not exist in the latest extended record control data area 32-3.

Also, at the time of the extending operation, there is a case that the predetermined data such as the dummy data is not recorded in the extended record control data area 32-3′ that has been used at that time. In such a case, the data stored in the buffer memory 212 is stored at the different timing from the above-mentioned. This is because that even if the record control data is not recorded in the latest extended record control data area 32-3, there is a case that the record control data recorded in the copied record control data area is not the latest. In other words, when the extended record control data area 32-3′ that has been used has a free space to record the record control data, the record control data is recorded additionally until the free space is filled even after the extending operation. Therefore, the latest record control data is recorded last in the extended record control data area 32-3′ that has been used immediately before the extending operation. As a result, in this record method, the record control data that has been recorded last in the extended record control data area 32-3′ is stored in the buffer memory 212 of the data recording and reproducing apparatus 1. Thus, if the latest extended record control data area has no data, the contents stored in the buffer memory 212 are handled as the latest record control data.

As mentioned up to this, the method has been described, of searching the latest record control data efficiently, and reproducing necessary data. Next, an operation of the data recording and reproducing apparatus 1 using the method will be described below.

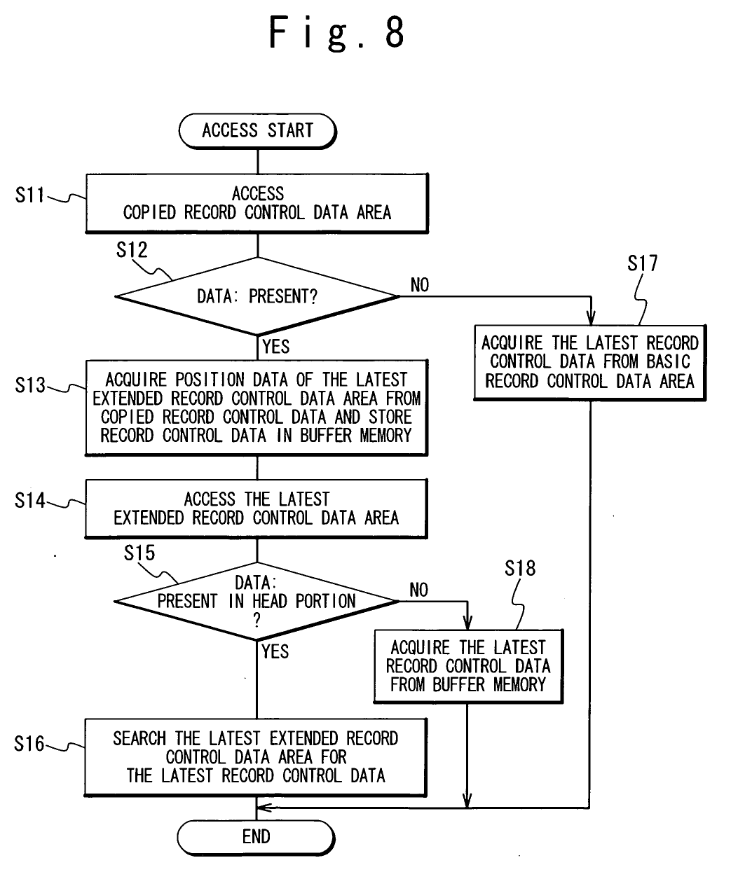

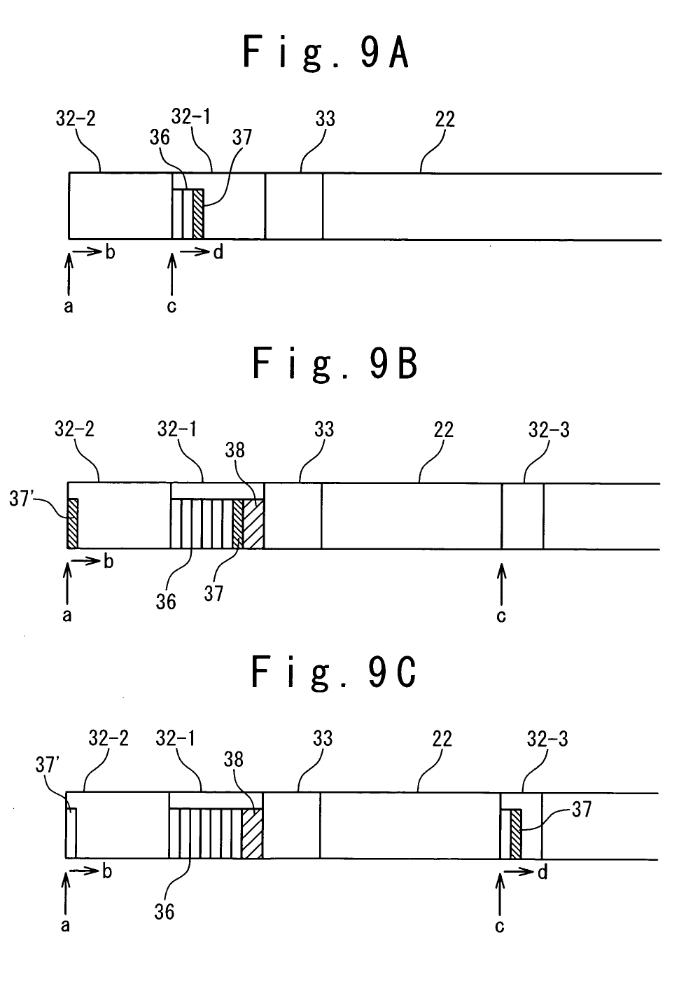

A first operation will be described with reference to FIGS. 8 and 9A to 9C. First, the recording state of each area of the optical disc medium 2 will be described with FIGS. 9A to 9C. As shown in FIG. 9A, the record control data 36 is recorded in the basic record control data area 32-1 as the user data is recorded in the data area 22 of the optical disc medium 2. The record control data recorded last becomes the latest record control data 37.

When the remaining capacity in the basic record control data area 32-1 becomes small, the record control data area 32 is extended. As shown in FIG. 9B, the extended record control data area 32-3 is set in a portion of the data area 22. The record control data at that time is recorded in the basic record control data area 32-1 as the latest record control data 37. Further, the copied record control data 37′ containing the position data of the extended record control data area 32-3 and the latest record control data 37 is recorded in the copied record control data area 32-2. Furthermore, a predetermined data is recorded in a remaining area 38 in the basic record control data area 32-1.

As the user data is recorded additionally, as shown in FIG. 9C, the record control data is recorded in the extended record control data area 32-3 sequentially. The latest record control data 37 at this time is the record control data recorded last in the extended record control data area 32-3.

When the remaining capacity in the extended record control data area 32-3 becomes small, a next extended record control data area is reserved in the data area 22, and the record control data area 32 is extended. A new copied record control data is recorded additionally in the copied record control data area 32-2 each time the record control data area 32 is extended. The unrecorded area remaining in the extended record control data area 32-3 is filled with the predetermined data, so that the extended record control data area 32-3 becomes an area fully recorded. Thus, the record control data area 32 is extended sequentially and the record control data is recorded, if the record capacity is decreased.

The operation of the data recording and reproducing apparatus 1 to reproduce the record control data from the optical disc medium 2 recorded in this way will be described with reference to a flow chart shown in FIG. 8. FIGS. 9A to 9C schematically show the accessing operation of the data recording and reproducing apparatus 1 from the respective areas of the optical disc medium 2. The symbols a to d in FIGS. 9A to 9C indicate the order of the access.

When the optical disc medium 2 is installed in the data recording and reproducing apparatus 1, the optical head 211 of the data recording and reproducing apparatus 1 initially accesses the copied record control data area 32-2 (step S11, arrow a in FIG. 9A).

The data recording and reproducing apparatus 1 determines whether the copied record control data is recorded in the copied record control data area 32-2 (step S12, arrow b in FIG. 9A). When the copied record control data is not recorded (step S12-No in FIG. 9A), the data recording and reproducing apparatus 1 accesses the basic record control data area 32-1 since the record control data area 32 is not extended (arrow c in FIG. 9A). The data recording and reproducing apparatus 1 reproduces the record control data 36 recorded in the basic record control data area 32-1, and acquires the latest record control data 37 recorded last (step S17, arrows d in FIG. 9A). When the copied record control data is recorded in the copied record control data area 32-2, the extension of the record control data area 32 has been carried out (step S12-Yes, FIGS. 9B and 9C). Therefore, the copied record control data 37′ having been recorded last in the reproduced copied record control data area 32-2 is stored in the buffer memory 212. The data recording and reproducing apparatus 1 acquires the position data of the latest extended record control data area 32-3 from the copied record control data 37′ (step S13).

Next, the data recording and reproducing apparatus 1 accesses the latest extended record control data area 32-3 based on the acquired position data (address) (step S14, arrow c in FIGS. 9B and 9C). The data recording and reproducing apparatus 1 determines whether the record control data is recorded in the latest extended record control data area 32-3 (step S15). When the record control data is not recorded in the head portion of the latest extended record control data area 32-3, the extension of the record control data area 32 has been carried out, but the extended record control data area 32-3 is not used for the record yet (step S15-No, FIG. 9B). In this case, the latest record control data is a record control data 37 that has been stored in the area used immediately before the expansion. The record control data 37 is contained in the copied record control data 37′ that has been recorded in the copied record control data area 32-2. Therefore, the data recording and reproducing apparatus 1 handles the record control data as the latest record control data in the copied record control data 37′ having been stored in the buffer memory 212 (step S18, FIG. 9B). When the head portion of the latest extended record control data area 32-3 has the record control data (step S15-Yes, FIG. 9C), the data recording and reproducing apparatus 1 accesses the head portion of the latest extended record control data area 32-3 initially, and acquires the latest record control data 37 in the end portion (step S16, arrow d in FIG. 9C).

In this way, the data recording and reproducing apparatus 1 can acquire the latest record control data. It should be noted that FIGS. 9A to 9C shows a case where the extended record control data area is provided through the first extension. However, the same accessing operation may be carried out in case of the secondary extension.

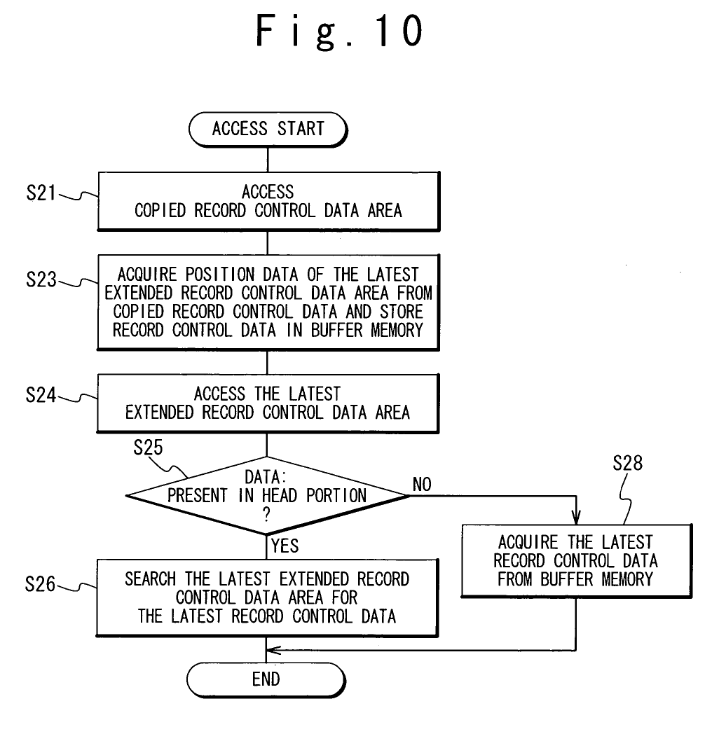

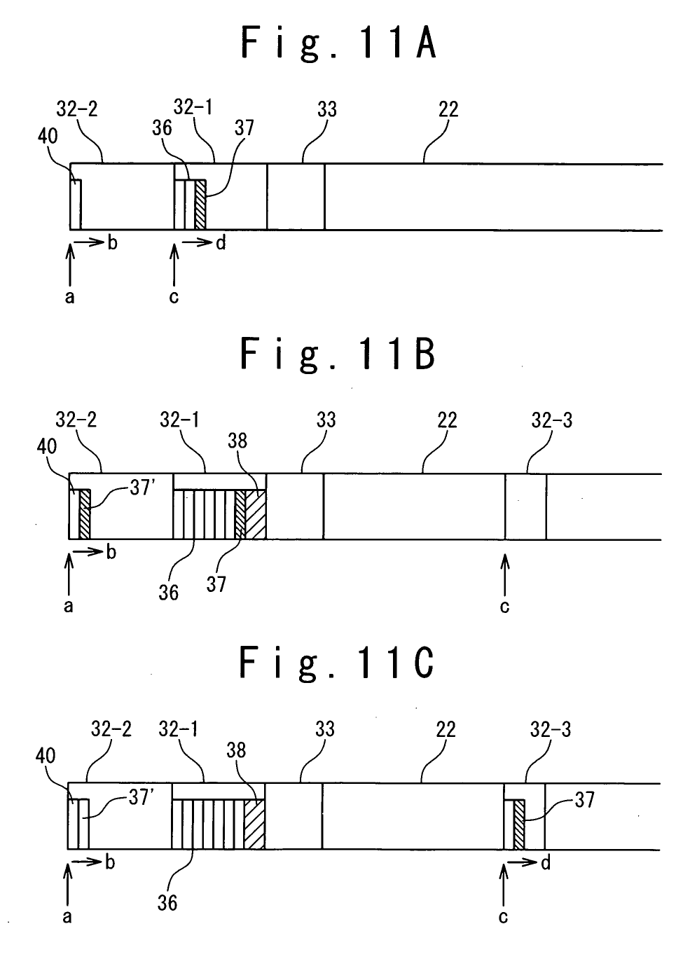

A second operation will be described with reference to FIG. 10 and FIGS. 11A to 11C. First, a recording state of each area in the optical disc medium 2 will be described with FIGS. 11A to 11C. As shown in FIG. 11A, when the recording operation in the optical disc medium 2 starts, the record control data is recorded in the basic record control data area 32-1, and the copied record control data 40 is also recorded in the copied record control data area 32-2. The copied record control data 40 includes a position data of the basic record control data area 32-1 as a data of the record control data area 32. Then, the record control data 36 is sequentially recorded in the basic record control data area 32-1 as the user data is recorded in the user data area 22 of the optical disc medium 2. The record control data that has been recorded last becomes the latest record control data 37.

When the remaining capacity of the basic record control data area 32-1 decreases, the record control data area 32 is extended. As shown in FIG. 11B, the extended record control data area 32-3 is set in a portion of the data area 22. The record control data at that time is recorded in the basic record control data area 32-1 as the latest record control data 37, and the copied record control data 37′ containing the position data of the extended record control data area 32-3 and the latest record control data 37 is also recorded in the copied record control data area 32-2. Moreover, the predetermined data is recorded in the unrecorded area 38 remained in the basic record control data area 32-1. As the user data is further recorded, the record control data is recorded in the extended record control data area 32-3 sequentially as shown in FIG. 11C. The latest record control data 37 is the record control data recorded last in the extended record control data area 32-3.

When the remaining capacity of the extended record control data area 32-3 decreases, the following extended record control data area is further set in the data area 22. A new copied record control data is recorded additionally in the copied record control data area 32-2 each time the record control data area 32 is extended. The unrecorded area remained in the extended record control data area 32-3 is filled with a predetermined data, and the extended record control data area 32-3 becomes an area fully recorded. Thus, the record control data area 32 is extended sequentially to record the record control data if its capacity is decreased.

Next, an operation of the data recording and reproducing apparatus 1 that reproduces the record control data from the optical disc medium 2 recorded in the above-mentioned way will be described with reference to a flow chart shown in FIG. 10. FIGS. 11A to 11C schematically show the accessing operation of the data recording and reproducing apparatus 1 with respect to each area of the optical disc medium 2. The symbols a to d in FIGS. 11A to 11C indicate the order of the access.

When the optical disc medium 2 is installed in the data recording and reproducing apparatus 1, the optical head 211 of the data recording and reproducing apparatus 1 initially accesses the copied record control data area 32-2 (step S21, arrow a in FIG. 11A). The data recording and reproducing apparatus 1 searches the copied record control data having been recorded last in the copied record control data area 32-2 to acquire the latest copied record control data (arrow b in FIG. 11A). The data recording and reproducing apparatus 1 stores the acquired latest copied record control data 40 (the copied record control data 37′ in FIGS. 11B and 11C) in the buffer memory 212 (step S23).

The data recording and reproducing apparatus 1 acquires the position data of the latest record control data area 32 from the latest copied record control data 40 (or the copied record control data 37′) and carries out the accessing operation based on the position data (step S24, arrow c in FIG. 11A). In this case, the latest copied record control data 40 has the position data (address) of the basic record control data area 32-1. Therefore, the data recording and reproducing apparatus 1 accesses the basic record control data area 32-1. On the other hand, in case of FIGS. 11B or 11C, the latest copied record control data 37′ has the position data (address) of the extended record control data area 32-3. Therefore, the data recording and reproducing apparatus 1 accesses the extended record control data area 32-3 based on the position data (step S24, arrows c in FIGS. 11B or 11C).

The data recording and reproducing apparatus 1 determines whether or not the record control data is recorded in a head portion of the accessed latest record control data area (step S25). As shown in FIG. 11A, in case of the basic record control data area 32-1 immediately before the extension, the record control data 36 or the latest record control data 37 is recorded. In this case and a case that some record control data are already recorded in the extended record control data area 32-3, as shown in FIG. 11C, the record control data is recorded in the head portion of the latest record control data area (step S25-Yes). Therefore, the data recording and reproducing apparatus 1 searches and acquires the latest record control data from the record control data area (step S26, arrow d in FIGS. 11A and 11C).

As shown in FIG. 11B, when the record control data is not recorded in the latest extended record control data area 32-3, area extension has been carried out and the predetermined data is recorded in the area that has been used. However, no record control data is recorded in the new extended area (step S25-No). In this case, the record control data is read out from the copied record control data that has been stored in the buffer memory 212 and handles it as the latest record control data 37 (step S28). This is because that the record control data 37 is recorded in the basic record control data area 32-1 or the extended record control data area 32-3′ when the extended record control data area 32-3 is set, and the record control data 37 is also recorded in the copied record control data area 32-2 as the copied record control data 37′. Thus, the copied record control data 37′ contains the latest record control data 37 and the data is stored in the buffer memory 212. Thus, the data recording and reproducing apparatus 1 can acquire the latest record control data. It should be noted that FIGS. 11A to 11C shows a case where the extended record control data area is provided through the first extension. The same accessing operation may be carried out in case of the second or subsequent extension.

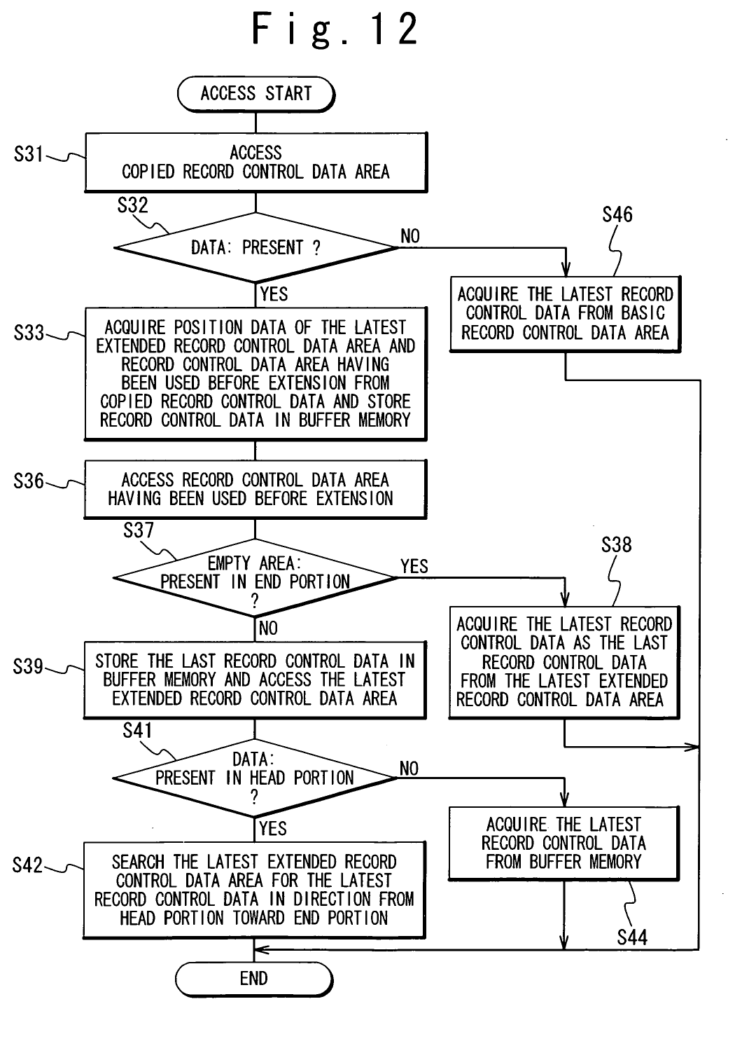

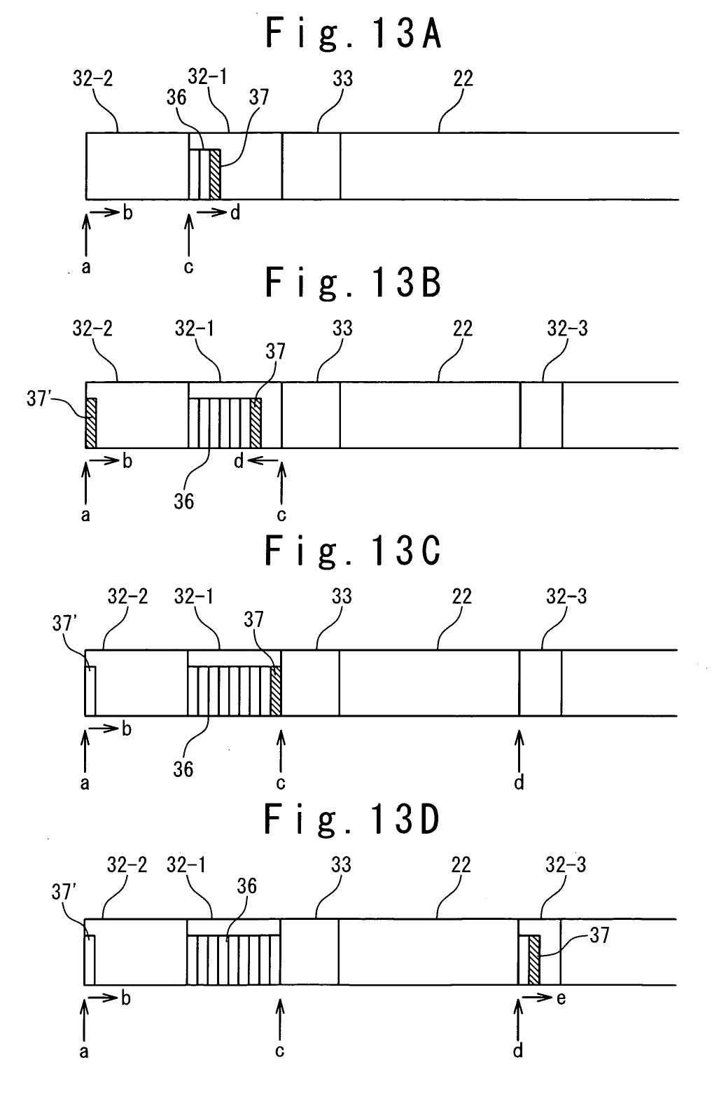

A third operation will be described with reference to FIGS. 12 and FIGS. 13A to 13D. First, recording states of the optical disc medium 2 will be described with FIGS. 13A to 13D. As shown in FIG. 13A, the record control data 36 is recorded in the basic record control data area 32-1 as the user data is recorded in the data area 22 of the optical disc medium 2. The record control data recorded last is the latest record control data 37.

When the remaining capacity of the basic record control data area 32-1 decreases, the record control data area 32 is extended. As shown in FIG. 13B, the extended record control data area 32-3 is set in a portion of the data area 22. The record control data at that time is recorded in the basic record control data area 32-1 as the latest record control data 37. In addition, the copied record control data 37′ containing the position data of the latest extended record control data area 32-3 and the record control data having been used immediately before the extension and the latest record control data 37 is recorded in recorded in the copied record control data area 32-2.

As shown in FIG. 13C, the data recording and reproducing apparatus 1 uses the basic record control data area 32-1 to record the user data until the unrecorded area of the basic record control data area 32-1 is all used to record the user data. Thus, the latest record control data 37 is recorded in the basic record control data area 32-1. The copied record control data having been recorded in the copied record control data area 32-2 becomes an old record control data since a new record control data is generated.

When the user data is further recorded after the basic record control data area 32-1 is fully used, the record control data is recorded in the extended record control data area 32-3 sequentially, as shown in FIG. 13D. The latest record control data 37 is the record control data has been recorded last in the extended record control data area 32-3.

When the remaining capacity of the extended record control data area 32-3 decreases, a next extended record control data area is set in the data area 22 to extend the record control data are 32. A new copied record control data is recorded additionally in the copied record control data area 32-2 each time the record control data area 32 is extended. The record control data is recorded in the extended record control data area 32-3 while the unrecorded area is remained in the extended record control data area 32-3. The data recording and reproducing apparatus 1 records the record control data in the extended record control data area newly set after the whole of extended record control data areas 32-3 has been used. Thus, the record control data area 32 is extended one after another as the record capacity decreases so as to record the record control data.

Next, an operation of the data recording and reproducing apparatus 1 that reproduces the record control data from the optical disc medium 2 recorded in this way will be described with reference to a flow chart shown in FIG. 12. FIGS. 13A to 13D schematically show the accessing operation of the data recording and reproducing apparatus 1 compared with each area of the optical disc medium 2. The symbols a to e in FIGS. 13A to 13D indicate the order of the access.

When the optical disc medium 2 is installed in the data recording and reproducing apparatus 1, the optical head 211 of the data recording and reproducing apparatus 1 initially accesses the copied record control data area 32-2 (step S31, arrow a in FIG. 13A). The data recording and reproducing apparatus 1 determines whether the copied record control data is recorded in the copied record control data area 32-2 (step S32). When the copied record control data is not recorded (step S32-No, FIG. 13A), the data recording and reproducing apparatus 1 accesses the basic record control data area 32-1 since the record control data area 32 is not extended (arrow c in FIG. 13A). The data recording and reproducing apparatus 1 reproduces the record control data 36 recorded in the basic record control data area 32-1, and acquires the latest record control data 37 has been recorded last (step S46, arrows d in FIG. 13A).

When the copied record control data is recorded in the copied record control data area 32-2, the extension of the record control data area 32 has been carried out (step S32-Yes, FIGS. 13B to 13D). Therefore, the data recording and reproducing apparatus 1 searches the copied record control data 37′ having been recorded last in the copied record control data area 32-2 (arrow b in FIGS. 13A to 13D) to store the data in the buffer memory 212. Moreover, the data recording and reproducing apparatus 1 acquires the position data of the latest extended record control data area 32-3 and the record control data area 32-1 having been used immediately before the extension from the copied record control data 37′ to store the position data in the buffer memory 212 (step S33).

Next, the data recording and reproducing apparatus 1 accesses the record control data area 32-1 having been used immediately before the extension based on the acquired position data (address) (step S36, arrows c in FIGS. 13B to 13D). The data recording and reproducing apparatus 1 determines whether a free space (an unrecorded area) is remained in the end potion of the record control data area 32-1 having been used immediately before the extension (step S37). When the unrecorded area is remained in the end portion of the record control data area 32-1 having been used immediately before the extension (step S37-Yes), the latest record control data 37 exists in this area. The data recording and reproducing apparatus 1 searches the data from the end portion of the area (arrows d in FIG. 13), and acquires the record control data that is retrieved first as the latest record control data 37 (step S38, FIG. 13B). The reason why the area is searched from the end portion is that the data recording and reproducing apparatus 1 can access the data speedily. The latest data exists in the end portion of the area since the recording starts from the head portion usually. The latest data is recorded on side nearer to the end portion of the area since little capacity is remained in this area at the extension. Therefore, it is possible to access the latest data more speedily by searching from the end portion of the area.

When the record control data is recorded to the end portion of the record control data area 32-1 having been used immediately before the extension and the unrecorded area is not remained (step S37-No), the data recording and reproducing apparatus 1 stores the record control data that has been recorded in the end portion, in the buffer memory 212. The data recording and reproducing apparatus 1 reads out the position data of the latest extended record control data area from the buffer memory 212 to access the latest extended record control data area 32-3 (step S39, arrows d in FIGS. 13C and 13D). The data recording and reproducing apparatus 1 determines whether the record control data is recorded in the latest extended record control data area 32-3 (step S41).

When the data is not recorded in the head portion (step S41-No), the latest record control data 37 has been recorded last in the record control data area 32-1 that has been used immediately before the extension (FIG. 13C). The record control data recorded last in the record control data area 32-1 that has been used immediately before the extension is stored in the buffer memory 212. Therefore, the data recording and reproducing apparatus 1 can acquire the data stored in the buffer memory 212 as the latest record control data (step S44).

When the record control data is recorded in the latest extended record control data area 32-3 (step S41-Yes), the latest record control data is recorded from the head or subsequent portion of this latest extended record control data area 32-3 (FIG. 13D). The data recording and reproducing apparatus 1 starts the search from the head portion toward the end portion to handle the record control data 37 recorded in the end portion as the latest record control data (step S38-2 and arrows e in FIG. 13D). Thus, the data recording and reproducing apparatus 1 can acquire the latest record control data. It should be noted that FIGS. 13A to 13D show a case where the extended record control data area is provided through the first extension. The same accessing operation may be carried out in case of the secondary extension.

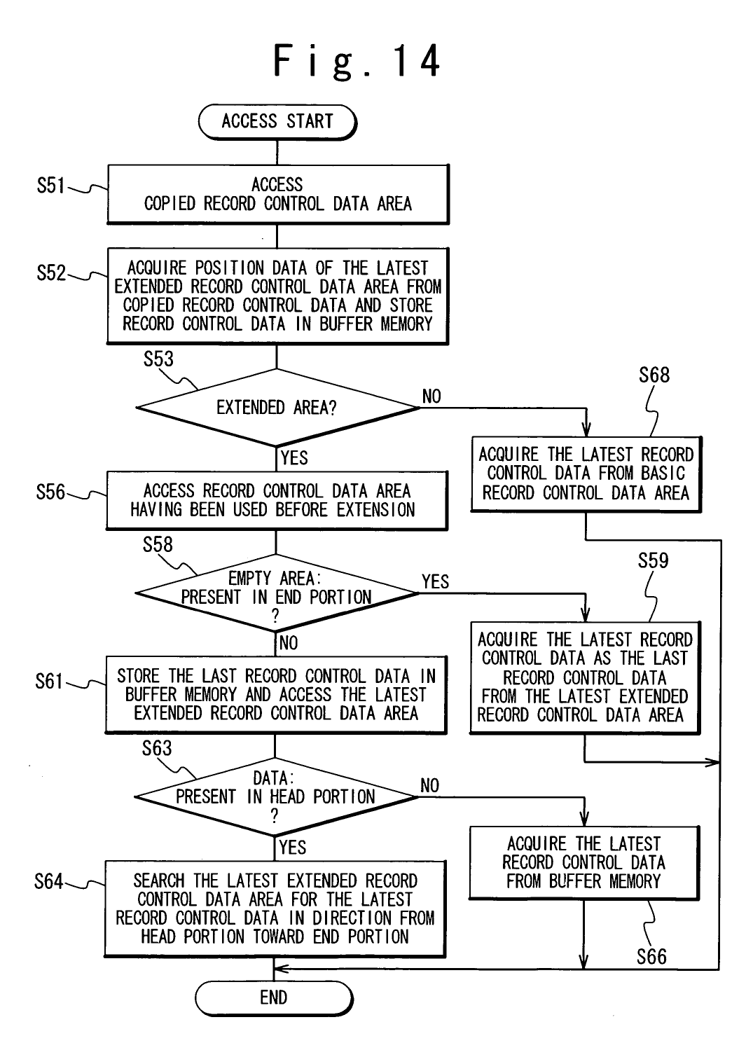

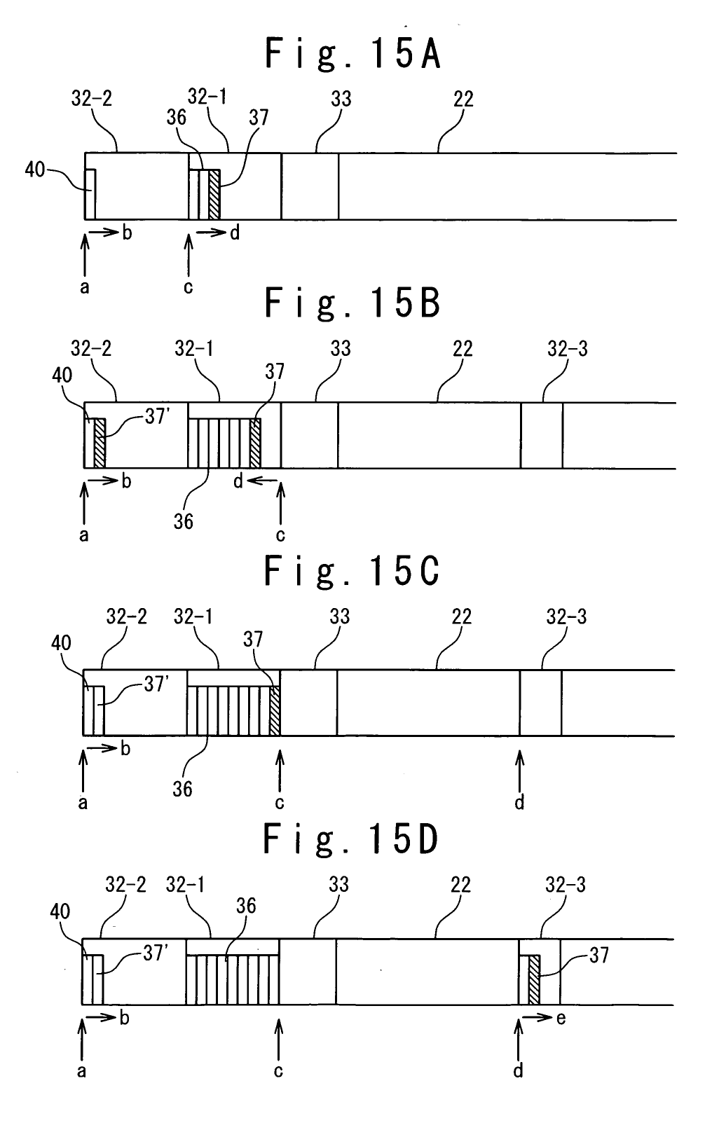

A fourth operation will be described with reference to FIG. 14 and FIGS. 15A to 15D. First, a recording state of each area in the optical disc medium 2 will be described with FIGS. 15A to 15D. As shown in FIG. 15A, when the recording operation in the optical disc medium 2 stars, the record control data is recorded in the basic record control data area 32-1, and the copied record control data 40 is also recorded in the copied record control data area 32-2. The copied record control data 40 contains addresses of the latest extended record control data areas and the record control data area that has been used immediately before the extension as a data of the record control data area 32. It should be noted that the address becomes a special data since it is an initial value. That is, the address of the basic record control data area 32-1 is registered as addresses of the latest extended record control data area and the record control data area that has been used immediately before the extension. It should be noted that the data are set as mentioned above, but other setting may be available. It is possible to cope with the other setting by changing a data source and the like in an operation as follows.

Afterwards, in accordance with the user data being recorded in the data area 22 of the optical disc medium 2, the record control data 36 is recorded in the basic record control data area 32-1. The record control data that has been recorded last becomes the latest record control data 37.

When the remaining capacity of the basic record control data area 32-1 decreases, the record control data area 32 is extended. As shown in FIG. 15B, the extended record control data area 32-3 is set in a portion of the data area 22. The record control data at that time is recorded in the basic record control data area 32-1 as the latest record control data 37. Further, the copied record control data 37′ is recorded in the copied record control data area 32-2, which contains the position data of the extended record control data area 32-3 and the latest record control data 37.

As shown in FIG. 15C, the data recording and reproducing apparatus 1 uses the basic record control data area 32-1 to record the user data until the unrecorded area of the basic record control data area 32-1 is entirely used. The latest record control data 37 is recorded in the basic record control data area 32-1. The copied record control data recorded in the copied record control data area 32-2 becomes an old record control data since a new record control data is generated.

When the user data is further recorded after the basic record control data area 32-1 is completely used, the record control data is recorded in the extended record control data area 32-3 sequentially as shown in FIG. 15D. The latest record control data 37 is the record control data recorded last in the extended record control data area 32-3.

When the remaining capacity of the extended record control data area 32-3 decreases, the next extended record control data area is further set in the data area 22. A new copied record control data is recorded additionally in the copied record control data area 32-2 each time the record control data area 32 is extended. The record control data is recorded in the extended record control data area 32-3 while the unrecorded area is remained in the extended record control data area 32-3. The data recording and reproducing apparatus 1 records the record control data in the extended record control data area newly set after the extended record control data areas 32-3 is fully used. Thus, the record control data area 32 is extended one after another as the record capacity decreases by recording the control data.

Next, an operation of such data recording and reproducing apparatus 1 that reproduces the record control data from the optical disc medium 2 recorded in this way will be described with reference to a flow chart shown in FIG. 14. FIGS. 15A to 15D schematically show the accessing operation of the data recording and reproducing apparatus 1 with respect to each area of the optical disc medium 2. The symbols a to e in FIG. 15 indicate the order of the access.

When the optical disc medium 2 is installed in the data recording and reproducing apparatus 1, the optical head 211 of the data recording and reproducing apparatus 1 initially accesses the copied record control data area 32-2 (step S51, arrow a in FIG. 15A). The data recording and reproducing apparatus 1 searches the copied record control data having been recorded last in the copied record control data area 32-2 to acquire the latest copied record control data (arrow b in FIG. 15A). The data recording and reproducing apparatus 1 stores in the buffer memory 212, the acquired latest copied record control data 40 (the copied record control data 40 in case of FIG. 15A, or the copied record control data 37′ in case of FIGS. 15B to 15D) (step S52).

The data recording and reproducing apparatus 1 acquires the position data of the latest record control data area 32 from the latest copied record control data 40 (or the copied record control data 37′). Then, the data recording and reproducing apparatus 1 determines whether the area indicates the basic record control data area 32-1 or indicates the extended record control data area 32-3 (step S53). When the extended record control data area 32-3 is not indicated but the basic record control data area 32-1 is indicated (step S53-No), the latest record control data 37 is stored in the basic record control data area 32-1. In this case, the copied record control data 40 is reproduced as the latest copied record control data. The data recording and reproducing apparatus 1 searches the basic record control data area 32-1 to acquire the latest record control data (step S68, arrows d in FIG. 15A).

When the latest record control data area 32 indicates the extended record control data area 32-3 (step S53-Yes), the data recording and reproducing apparatus 1 reads out the address of the latest extended record control data area contained in the copied record control data reproduced from the copied record control data area 32-2, and the address of the record control data area that has been used immediately before the extension. Then, the data recording and reproducing apparatus stores the addresses in the buffer memory 212. Further, the data recording and reproducing apparatus 1 accesses the basic record control data area 32-1 on the basis of the address of the record control data area that has been used immediately before the extension. At this time, the record control data area having been used immediately before the extension is searched from the end portion (step S56, arrows c and d in FIGS. 15B to 15D). The latest data exists in the end portion since the data is recorded from the head portion usually. At the extension, the latest data must be recorded on the side nearer to the end portion since the remaining capacity of this area becomes a little. Therefore, it is possible to access the latest data more quickly by searching from the end portion. The data recording and reproducing apparatus 1 determines whether the record control data is recorded in the end portion of the record control data area 32-1 or the area is a free space in an unrecorded state (step S58, arrows c in FIGS. 15B to 15D).

When the end portion of the record control data area 32-1 having been used immediately before the extension is a free space, and the record control data is not recorded (step S58-Yes, FIG. 15(2)), the data recording and reproducing apparatus 1 searches the record control data from the end portion of the record control data area 32-1. Then, the data recording and reproducing apparatus 1 acquires the record control data searched first, that is, the record control data having been recorded last, as the latest record control data 37 (step S59, arrow d in FIG. 15B).

When the record control data has been recorded in the end portion of the record control data area 32-1 having been used immediately before the extension (step S58-No, FIGS. 15C and 15d), the data recording and reproducing apparatus 1 stores the record control data in the end portion in the buffer memory 212. The data recording and reproducing apparatus 1 accesses the extended record control data area 32-3 that is the latest extended record control data area on the basis of the address of the latest extended record control data area having been stored in the buffer memory 212 (step S61). The data recording and reproducing apparatus 1 determines whether or not the record control data is recorded in the head portion of the extended record control data area 32-3 (step S63, arrow d in FIGS. 15C and 15D).

When the record control data is not recorded in the head portion of the extended record control data area 32-3 (step S63-No, FIG. 15C), the data recording and reproducing apparatus 1 handles the record control data stored in buffer memory 212 as the latest record control data (step S66). When the record control data is recorded in the head portion of the extended record control data area 32-3(step S63-Yes, FIG. 15D), the latest record control data is recorded in the backward of the head portion of this area. Therefore, the data recording and reproducing apparatus 1 starts the searching operation from the head portion to acquire the record control data having been recorded last in this area as the latest record control data 37 (step S64, arrow e in FIG. 15D). Thus, the data recording and reproducing apparatus 1 can acquire the latest record control data. It should be noted that FIGS. 15a to 15D show a case where the extended record control data area is provided through the first extension. The same accessing operation may be carried out in case of the second or subsequent extension.

In the embodiments of the present invention, the copied record control data has been described as the record control data contains the position data of the extended record control data area. However, the position data of the extended record control data area may be contained in the record control data. In this case, it is clear that the same operation as the above-mentioned is achieved.

As mentioned up to this, in accordance with the data recording and reproducing method of the present invention, it is possible to access the desired latest record control data in a few access procedures and to achieve high speed operation of the apparatus, even if the record control data area is extended.

According to the present invention, it is possible to read out the latest record control data quickly in a few procedures by accessing once the record control data area that has been used immediately before the extension, instead of the latest extended record control data area, and by adopting the method of searching from the end portion of the area.

Moreover, in the present invention, the buffer memory is installed in the data recording and reproducing apparatus, and the record control data recorded previously in the copied record control data area is stored in the buffer memory, or the data have been recorded last in the record control data area having been used immediately before the extension is stored in the buffer memory. As a result, when the record control data does not exist in accessing the latest extended record control data area, the data stored in this buffer memory is used. Therefore, a re-searching operation is unnecessary and the record control data can be acquired quickly in a few procedures.

Further, in the present invention, the copy data of the record control data recorded in the first record control data area may be recorded in this copied record control data area even before the extended record control data area is set. As a result, it is possible to surely know whether the area extension has been carried out only by accessing the copied record control data area, resulting in improvement of reliability of the apparatus operation In the above-mentioned embodiments, the operation has been described mainly as for the searching operation of the record control data area that has been extended for the first time. However, the same operation procedures can be applied to the searching operation of the record control data area extended for the second or subsequent time. Moreover, the similar operation procedures can be applied even if the extended copied record control data area is formed as the border area of the multi-border format.

1. A method of carrying out a recording operation and a reproducing operation to a data record medium, comprising:
extending a record control data area in a data area, wherein said data record medium comprises said data area, and a system area containing at least one of record control data areas, in each of which record control data for user data recorded in said data area has been recorded; and
recording a replica of said record control data containing a latest record control data in a predetermined replica record control data area of said data record medium when said record control data area is extended.

2. The method according to claim 1, wherein said replica record control data contains at least one of a data indicating a position of said extended record control data area and a data indicating a position of a currently used one of said record control data areas.

3. The method according to claim 1, further comprising:
recording said record control data of said record control data area in said replica record control data area, after an initial setting which is carried out on a first use of said data record medium.

4. The method according to claim 1, further comprising:
searching said latest record control data having been recorded in said data record medium,
wherein said searching comprises:
acquiring a data indicating positions of said record control data areas based on said replica record control data; and
when said record control data area is extended last, accessing said record control data area having been used immediately before the last extension.

5. The method according to claim 4, wherein said accessing said record control data area having been used immediately before the last extension, comprises:
determining whether or not said record control data is recorded in an end portion of said record control data area having been used immediately before the last extension;
searching said latest record control data in a direction from said end portion of said record control data area having been used immediately before the last extension toward a head portion thereof, when it is determined that said record control data has not been recorded in the end portion of said record control data area having been used immediately before the last extension;
acquiring as said latest record control data, said record control data searched first in said record control data area having been used immediately before the last extension;
temporarily storing said record control data having been recorded in the end portion of said record control data having been used immediately before the last extension, when it is determined that said record control data has been recorded in the end portion of said record control data; and
accessing said last extended record control data area, after said temporary storing.

6. The method according to claim 5, wherein said accessing said last extended record control data area, comprises:
determining whether or not said record control data has been recorded in said last extended record control data area;
acquiring the temporarily stored record control data as said latest record control data when it is determined that said record control data has not been recorded in said last extended record control data area; and
acquiring said record control data having been recorded last in said last extension record control data area as said latest record control data when it is determined that said record control data has been recorded in said last extended record control data area.

7. A method of carrying out a recording operation and a reproducing operation to a data record medium, comprising:
extending a record control data area in a data area, wherein said data record medium comprises said data area, and a system area containing at least one of record control data areas, in each of which record control data for user data recorded in said data area has been recorded;
recording a replica of said record control data containing a latest record control data in a predetermined replica record control data area of said data record reproduction medium; and
recording a predetermined data in a non-record area of said record control data area.

8. The method according to claim 7, wherein said replica record control data contains a data indicating a position of said record control data area extended in said data area.

9. The method according to claim 7, further comprising:
recording said record control data of said record control data area in said replica record control data area, after initial setting which is carried out on a first use of said data record medium.

10. The method according to claim 7, further comprising:
searching said latest record control data in said data record reproduction medium;
wherein said searching comprises:
acquiring a data indicating positions of said record control data areas based on said replica record control data;
temporarily storing said replica record control data;
determining whether or not said record control data has been recorded in a last extended one of said record control data areas;
acquiring said record control data recorded last in said last extended record control data area as said latest record control data when it is determined that said record control data has been recorded; and
acquiring the temporarily stored replica record control data as said latest record control data when it is determined that said record control data has not been recorded.

11. A data recording and reproducing apparatus comprising:
a recording section configured to write-access a data record medium;
a reproducing section configured to read-access said data record medium; and
a control section configured to control said recording section and said reproducing section,
wherein said data record medium comprises a data area, and a system area containing at least one of record control data areas, in each of which record control data for user data recorded in said data area has been recorded, and
said control section controls said recording section to extend said record control data area in said data area, and to record a replica of said record control data containing a latest record control data in a predetermined replica record control data area of said data record medium when said record control data area is extended.

12. The data recording and reproducing apparatus according to claim 11, wherein said replica record control data contains at least one of a data indicating a position of said extended record control data area and a data indicating a position of a currently used one of said record control data areas.

13. The data recording and reproducing apparatus according to claim 11, wherein said control section controls said recording section to record said record control data of said record control data area in said replica record control data area, after an initial setting which is carried out on a first use of said data record medium.

14. The data recording and reproducing apparatus according to claim 11, further comprising:
said control section controls said reproducing section to acquire a data indicating positions of said record control data areas based on said replica record control data, and
said control section controls said reproducing section to access said record control data area having been used immediately before the last extension when said control section controls said recording section to extend said record control data area last.

15. The data recording and reproducing apparatus according to claim 14, further comprising a buffer memory,
wherein said control section determines whether or not said record control data is recorded in an end portion of said record control data area having been used immediately before the last extension,
said control section controls said reproducing section to search said latest record control data in a direction from said end portion of said record control data area having been used immediately before the last extension toward a head portion thereof, when said control section determines that said record control data has not been recorded in the end portion of said record control data having been used immediately before the last extension, and to acquire as said latest record control data, said record control data searched first through said search,
said control section temporarily stores said record control data having been recorded in the end portion of said record control data having been used immediately before the last extension in said buffer memory, when said control section determines that said record control data has been recorded in the end portion of said record control data area, and
said control section controls said reproducing section to access said last extended record control data area, after said temporary storing.

16. The data recording and reproducing apparatus according to claim 15, wherein said control section determines whether or not said record control data has been recorded in said last extended record control data area,
said control section controls said reproducing section to acquire the temporarily stored record control data as said latest record control data when said control section determines that said record control data has not been recorded in said last extended record control data area, and
said control section controls said reproducing section to acquire said record control data having been recorded last in said last extension record control data area as said latest record control data when said control section determines that said record control data has been recorded in said last extended record control data area.

17. A data recording and reproducing apparatus comprising:
a recording section configured to write-access a data record medium;
a reproducing section configured to read-access said data record medium; and
a control section configured to control said recording section and said reproducing section,
wherein said data record medium comprises a data area, and a system area containing at least one of record control data areas, in each of which record control data for user data recorded in said data area has been recorded, and
said control section controls said recording section to extend said record control data area in said data area, to record a replica of said record control data containing a latest record control data in a predetermined replica record control data area of said data record reproduction medium, and to record a predetermined data in a non-record area of said record control data area.

18. The data recording and reproducing apparatus according to claim 17, wherein said replica record control data contains a data indicating a position of said record control data area extended in said data area.

19. The data recording and reproducing apparatus according to claim 17, wherein said control section controls said recording section to record said record control data of said record control data area in said replica record control data area, after initial setting which is carried out on a first use of said data record medium.

20. The data recording and reproducing apparatus according to claim 17, further comprising a buffer memory,
wherein said control section controls said reproducing section to acquire a data indicating positions of said record control data areas based on said replica record control data,
said control section temporarily stores said replica record control data in said buffer memory, and determines whether or not said record control data has been recorded in a last extended one of said record control data areas, and
said control section controls said reproducing section to acquire said record control data recorded last in said last extended record control data area as said latest record control data when said control section determines that said record control data has been recorded, and to acquire the temporarily stored replica record control data as said latest record control data when said control section determines that said record control data has not been recorded.
